(19) United States
(12) Patent Application Publication
(10) Pub. No.: US 2007/0217195 A1
(43) Pub. Date: Sep. 20, 2007

(54) LIGHT-EMITTING DEVICE AND A LENS THEREOF

(75) Inventors: Yen-Cheng Chen, Taipei Hsien (TW); Ching-Lin Tseng, Taipei Hsien (TW); Liang-Tang Chen, Tainan Hsien (TW); Chung-Kai Wang, Taipei Hsien (TW); Ming-Li Chang, Taipei Hsien (TW)

Correspondence Address: DARBY & DARBY P.C., P.O. BOX 770, Church Street Station, New York, NY, 10008-0770, US

(73) Assignee: BRIGHT LED ELECTRONICS CORP., Taipei Hsien (TW)

(21) Appl. No.: 11/619,704

(22) Filed: Jan. 4, 2007

(30) Foreign Application Priority Data
Mar. 15, 2006 (TW) 095108742

(51) Int. Cl. F21V 14/00

(52) U.S. Cl. 362/255

(57) ABSTRACT

A lens includes a lens body having a bottom surface, a reflective surface, and a refractive surface. The bottom surface is to be disposed proximate to a light-emitting component. The reflective surface is disposed opposite to the bottom surface along a lens axis, and reflects a first portion of the light provided by the light-emitting component that is incident thereon toward the refractive surface. The refractive surface extends from an edge of the reflective surface to the bottom surface, and refracts a second portion of the light provided by the light-emitting component that is incident thereon as well as the first portion of the light reflected by the reflective surface theretoward in sideward directions relative to the light-emitting component. The lens body has cross-sections transverse to the lens axis, sizes of which increase gradually from a junction of the reflective surface and the refractive surface toward the bottom surface.

### CROSS-REFERENCE TO RELATED APPLICATION

This application claims priority of Taiwanese Application No. 095108742, filed on Mar. 15, 2006.

### BACKGROUND OF THE INVENTION

1. Field of the Invention

The invention relates to a light-emitting device, more particularly to a light-emitting device and a lens thereof for directing light provided by a light-emitting component of the light-emitting device sideways.

2. Description of the Related Art

As shown in FIG. 1, U.S. Pat. No. 6,607,286 discloses a lens for directing light provided by a light-emitting diode 1 sideways. The lens includes a lens body that has a bottom surface 11, a total reflective surface 12, a first refractive surface 13, and a second refractive surface 14. The total reflective surface 12 has a funnel shape for reflecting a first portion of the light emitted by the light-emitting diode 1 and traveling through the bottom surface 11 (i.e., the portion of the light forming relatively small angles with a lens axis 10 of the lens) that is incident thereon sideways. The light reflected by the total reflective surface 12 is then refracted by the first refractive surface 13, and eventually travels approximately perpendicular to the lens axis 10 out of the lens. The second refractive surface 14 has a sawtooth cross section, and refracts a second portion of the light emitted by the light-emitting diode 1 and traveling through the bottom surface 11 (i.e., the portion of the light forming relatively large angles with the lens axis 10) that is incident thereon in directions approximately perpendicular to the lens axis 10 out of the lens.

However, because the shape of the lens is complicated (i.e., including a sawtooth surface), not only is mold design difficult, but mold release is also hard to perform. In addition to the high cost attributed to fabrication of the mold, manufacturing of the lens is complex and tedious, and is especially difficult when high precision is required. In addition, although the lens is used to direct light sideways, there is still a significant amount of light (approximately 10% to 20%) that travels approximately parallel to the lens axis 10 due to failure to comply with critical angle requirement for total internal reflection.

Shown in FIG. 2 is another lens for directing light provided by a light-emitting diode 1 sideways. Since the total reflective surface 12′ and the first refractive surface 13′ form an acute angle therebetween, as with the previous lens, the lens of FIG. 2 is also difficult to manufacture.

### SUMMARY OF THE INVENTION

Therefore, the main object of the present invention is to provide a lens for directing light provided by a semiconductor light-emitting component sideways.

According to one aspect of the present invention, there is provided a lens for directing light provided by a light-emitting component sideways. The lens includes a lens body having a bottom surface, a reflective surface, and a refractive surface. The bottom surface is to be disposed proximate to the light-emitting component. The reflective surface is disposed opposite to the bottom surface along a lens axis, and reflects a first portion of the light provided by the light-emitting component that is incident thereon toward the refractive surface. The refractive surface extends from an edge of the reflective surface to the bottom surface, and refracts a second portion of the light provided by the light-emitting component that is incident thereon as well as the first portion of the light reflected by the reflective surface theretoward in sideward directions relative to the light-emitting component. The lens body has cross-sections transverse to the lens axis, sizes of which increase gradually from a junction of the reflective surface and the refractive surface toward the bottom surface.

According to another aspect of the present invention, there is provided a lens for directing light provided by a light-emitting component sideways. The lens includes a lens body having a bottom surface, a wavy surface, and a refractive surface. The bottom surface is to be disposed proximate to the light-emitting component. The wavy surface is disposed opposite to the bottom surface along a lens axis, and is capable of reflecting a first portion of the light provided by the light-emitting component that is incident thereon toward the refractive surface. The refractive surface extends from an edge of the wavy surface to the bottom surface, and refracts a second portion of the light provided by the light-emitting component that is incident thereon as well as the first portion of the light reflected by the wavy surface theretoward in sideward directions relative to the light-emitting component.

Another object of the present invention is to provide a light-emitting device capable of emitting light in sideward directions.

According to yet another aspect of the present invention, there is provided a light-emitting device that includes a base, a light-emitting component, and a lens. The light-emitting component is mounted on the base. The lens directs light emitted by the light-emitting component sideways. The lens includes a lens body that has a bottom surface, a reflective surface, and a refractive surface. The bottom surface is disposed proximate to the light-emitting component. The reflective surface is disposed opposite to the bottom surface along a lens axis, and reflects a first portion of the light provided by the light-emitting component that is incident thereon toward the refractive surface. The refractive surface extends from an edge of the reflective surface to the bottom surface, and refracts a second portion of the light provided by the light-emitting component that is incident thereon as well as the first portion of the light reflected by the reflective surface theretoward in sideward directions relative to the light-emitting component. The lens body has cross-sections transverse to the lens axis, sizes of which increase gradually from a junction of the reflective surface and the refractive surface toward the bottom surface.

According to still another aspect of the present invention, there is provided a light-emitting device that includes a base, a light-emitting component, and a lens. The light-emitting component is mounted on the base. The lens directs light emitted by the light-emitting component sideways. The lens includes a lens body that has a bottom surface, a wavy surface, and a refractive surface. The bottom surface is disposed proximate to the light-emitting component. The wavy surface is disposed opposite to the bottom surface along a lens axis, and is capable of reflecting a first portion of the light provided by the light-emitting component that is incident thereon toward the refractive surface. The refractive surface extends from an edge of the wavy surface to the bottom surface, and refracts a second portion of the light provided by the light-emitting component that is incident thereon as well as the first portion of the light reflected by the wavy surface theretoward in sideward directions relative to the light-emitting component.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a lens in the prior art;

FIG. 2 is a schematic view of another lens in the prior art;

FIG. 3 is a schematic view of the first preferred embodiment of a light-emitting device according to the present invention;

FIG. 4 is a plot illustrating results of an experiment conducted to test the efficiency of the first preferred embodiment;

FIG. 5 is a flow chart showing steps of a first method for making the light-emitting device according to the first preferred embodiment;

FIG. 6 is a schematic diagram illustrating the first method;

FIG. 7 is a flow chart showing steps of a second method for making the light-emitting device according to the first preferred embodiment;

FIG. 8 is a schematic diagram of a lens cap used in the second method;

FIG. 9 is a flow chart showing steps of a third method for making the light-emitting device according to the first preferred embodiment;

FIG. 10 is a schematic view of the second preferred embodiment of a light-emitting device according to the present invention;

FIG. 11 is an enlarged fragmentary view showing a reflective surface of a lens according to the second preferred embodiment;

FIG. 12 is a plot illustrating results of an experiment conducted to test the efficiency of the second preferred embodiment;

FIG. 13 is a schematic view of the third preferred embodiment of a light-emitting device according to the present invention; and

FIG. 14 is a plot illustrating results of an experiment conducted to test the efficiency of the third preferred embodiment.

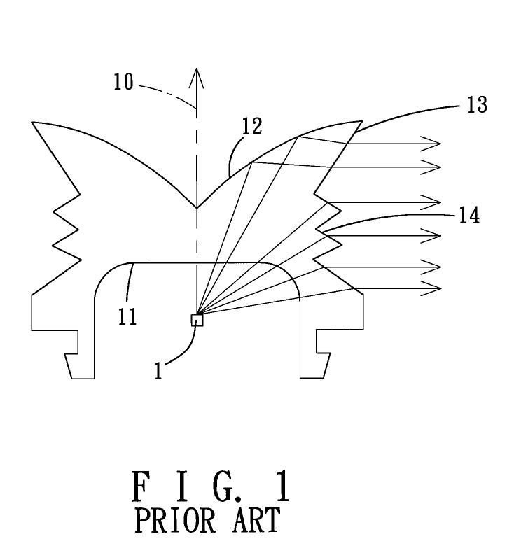

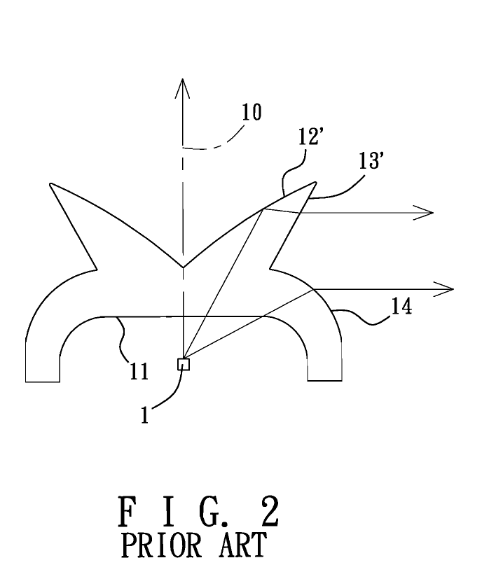

### DETAILED DESCRIPTION OF THE PREFERRED EMBODIMENTS

Before the present invention is described in greater detail, it should be noted herein that like elements are denoted by the same reference numerals throughout the disclosure.

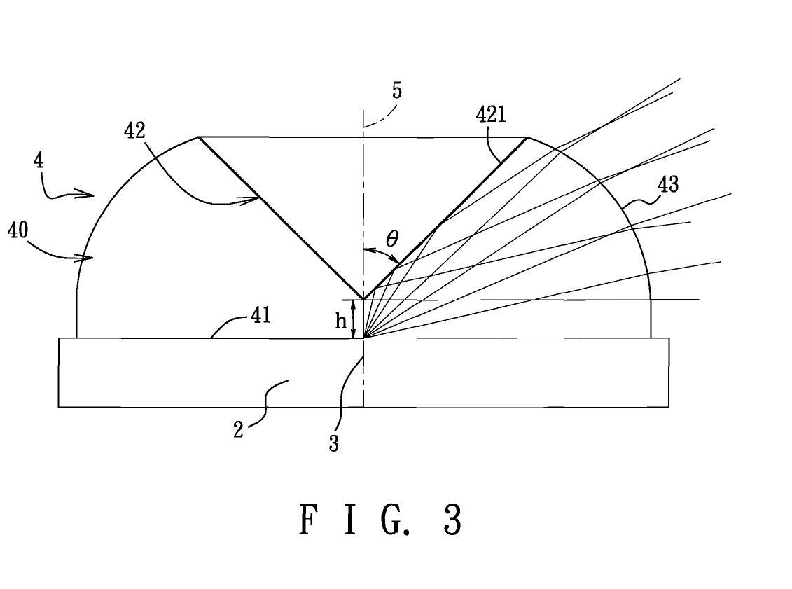

As shown in FIG. 3, the first preferred embodiment of a light-emitting device according to the present invention includes a base 2, a semiconductor light-emitting component 3, and a lens 4. The light-emitting component 3 is mounted on the base 2 and is disposed below the lens 4, i.e., the light-emitting component 3 is disposed between the base 2 and the lens 4. The light-emitting device has a central lens axis 5, and the light-emitting component 3 and the lens 4 are both symmetrical or substantially symmetrical about the central lens axis 5.

The base 2 is one that is commonly employed in conventional semiconductor light-emitting packages, and it can be but is not limited to a plastic coated metal support, an upright support, a planar support, or a piranha support. The light-emitting component 3 is mounted on the base 2 by wire bonding. Since wire bonding is a technique known to those skilled in the art, further details of the same are omitted herein for the sake of brevity.

The lens 4 directs light emitted by the light-emitting component 3 in sideward directions. The lens 4 can be made by injection molding a light-transmissive high molecular thermoplastic material, such as polymethyl methacrylate (PMMA), polycarbonate (PC), or can be made by casting a light-transmissive thermosetting plastic, such as epoxy resin or silicone. The lens 4 can also be molded from glass. Preferably, the index of refraction for the lens 4 ranges between 1.2 and 1.8.

The lens 4 includes a lens body 40 that has a bottom surface 41, a reflective surface 42, and a refractive surface 43. The bottom surface 41 is disposed proximate to the light-emitting component 3 and is coupled to the base 2. The reflective surface 42 is disposed opposite to the bottom surface 41 along the central lens axis 5, and is shaped as a conical surface so as to define a funnel-shaped space having a center point that is passed by the central lens axis 5. The reflective surface 42 is provided with a reflective coating layer 421, which can be partially optically-transmissive or completely optically non-transmissive, and which can have various thicknesses depending on practical requirements. The reflective surface 42 completely or partially reflects a first portion of the light provided by the light-emitting component 3 that travels through the bottom surface 41 and that is incident on the reflective surface 42 toward the refractive surface 43. The refractive surface 43 extends from a topmost edge of the reflective surface 42 to the bottom surface 41. In this embodiment, the refractive surface 43 is a curved surface or a part of a spherical surface. The refractive surface 43 refracts a second portion of the light provided by the light-emitting component 3 that travels through the bottom surface 41 and that is incident on the refractive surface 43 as well as the first portion of the light that is reflected by the reflective surface 42 toward the refractive surface 43 in sideward directions relative to the light-emitting component 3.

The lens body 40 has cross-sections transverse to the central lens axis 5, sizes of which increase gradually from a junction of the reflective surface 42 and the refractive surface 43 toward the bottom surface 41. Therefore, a projection of an outer periphery of an upper body part of the lens body 40 on the bottom surface 41 is completely surrounded by a projection of an outer periphery of a lower body part of the lens body 40 on the bottom surface 41.

Described hereinbelow are principles behind the light-emitting device.

First, a first portion of the light provided by the light-emitting component 3 is incident on the reflective surface 42, and a second portion of the light provided by the light-emitting component 3 is incident on the refractive surface 43. Define an angle θ between the central lens axis 5 and the reflective surface 42. Preferably, the angle θ ranges between 49′ and 62′. Let the distance between a lowermost point of the reflective surface 42 and the bottom surface 41 be denoted as (h). Preferably, the distance (h) ranges between 0.8 mm and 1.4 mm.

Surface processing techniques, such as coating, injection, metal plating, vapor deposition, etc., can be used to form the reflective coating layer 421 on the reflective surface 42 in order to increase the reflectivity of the reflective surface 42. Therefore, the reflective surface 42 is capable of reflecting the first portion of the light provided by the light-emitting component 3 that travels through the bottom surface 41, and that forms relatively small angles with the central lens axis 5 in sideward directions toward the refractive surface 43. The refractive surface 43 then refracts this portion of the light out of the lens 4. On the other hand, the second portion of the light provided by the light-emitting component 3 that travels through the bottom surface 41, and that forms relatively large angles with the central lens axis 5 is incident directly on the refractive surface 43, and is refracted by the refractive surface 43 in sideward directions out of the lens 4. The sideward directions are substantially perpendicular to the central lens axis 5.

Therefore, the lens 4 of the light-emitting device according to the present invention is capable of re-directing the light provided by the light-emitting component 3 from scattering in upward directions to traveling in sideward directions. In addition, the reflective coating layer 421 not only enhances the efficiency of the reflective surface 42 in reflecting light, but also significantly reduces a portion of the light provided by the light-emitting component 3 that travels through the bottom surface 41 and that is incident on a center portion of the reflective surface 42 from traveling directly through the lens 4.

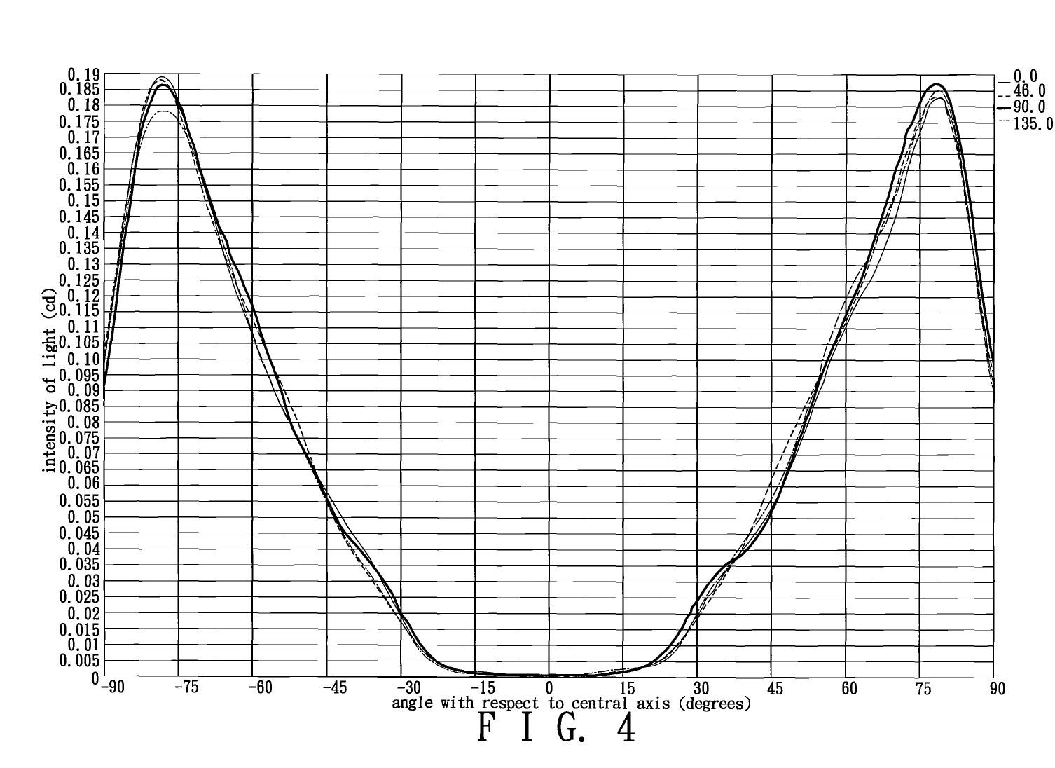

Shown in FIG. 4 are results of an experiment conducted to test the efficiency of the light-emitting device according to the present invention. It can be seen from FIG. 4 that the intensity of radiated light forming relatively small angles (0° to 15°) with the central lens axis 5 is approximately zero, and the intensity of radiated light forming angles of approximately 80° with the central lens axis 5 is the highest. Naturally, since the material and the thickness of the reflective coating layer 421 can be designed to allow partial transmission of light therethrough, the intensity of radiated light forming angles of 0° to 15° with the central lens axis 5 is not necessarily zero.

The light-emitting device according to the first preferred embodiment will be better understood with reference to the following description on a manufacturing method thereof.

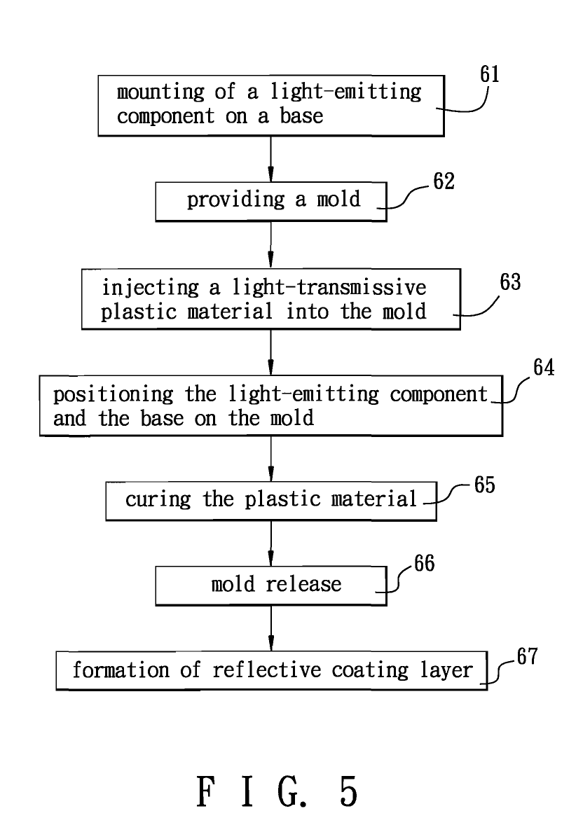

As shown in FIG. 5, the method begins in step 61, where the light-emitting component 3 is mounted on the base 2 by wire bonding. A plurality of light-emitting components 3 and a plurality of bases 2 are used in this embodiment as an illustration, where the bases 2 are arranged in a line or an array. It should be noted herein that this method can also be applied to an embodiment including a single light-emitting component 3 and a single base 2.

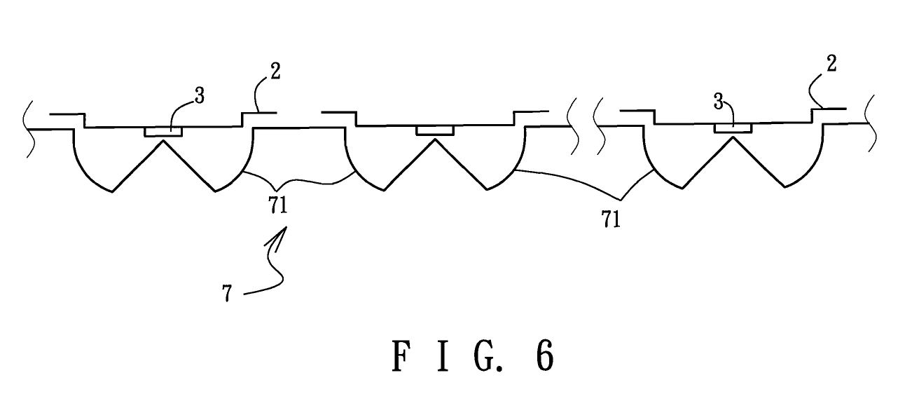

Subsequently, a mold 7 is provided in step 62. As shown in FIG. 6, the mold 7 is formed with a plurality of mold cavities 71, which can be arranged in a line or an array. Each of the mold cavities 71 has a shape corresponding to that of the lens 4.

A light-transmissive plastic material is then injected into the mold cavities 71 in step 63. The plastic material can be but is not limited to thermosetting plastic such as epoxy resin or silicone.

Next, the bases 2, along with the light-emitting components 3, are positioned on the mold 7 above the mold cavities 71, respectively, in step 64. As illustrated in FIG. 6, each of the bases 2 is disposed upside down on the mold 7 such that the corresponding light-emitting component 3 is immersed in the plastic material.

Later, the plastic material is cured in step 65 by baking. In step 66, the cured plastic material is released from the mold 7, where the cured plastic material is the lens body 40 formed and shaped in the way described previously.

Lastly, the reflective coating layer 421 is formed on the lens body 40, which can be done by but is not limited to coating, injection, metal plating, or vapor deposition in step 67.

It should be noted herein that since the lens body 40 is shaped such that the projection of the outer periphery of the upper body part on the bottom surface 41 is completely surrounded by that of the lower body part on the bottom surface 41, mold release is very easy. In addition, yield of the finished product is high. It should be noted herein that steps 63 and 64 can be interchanged in sequence without affecting the final result. Further, the arrangement of the mold 7 and the bases 2 can be reversed in other embodiments, i.e., in the way shown by flipping FIG. 6 upside down.

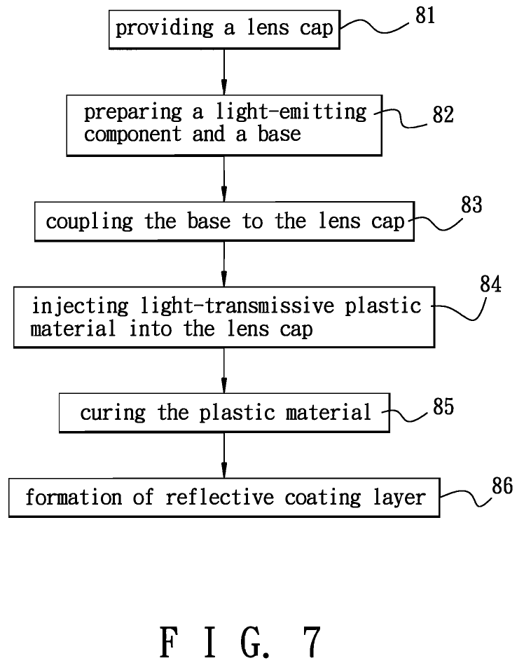

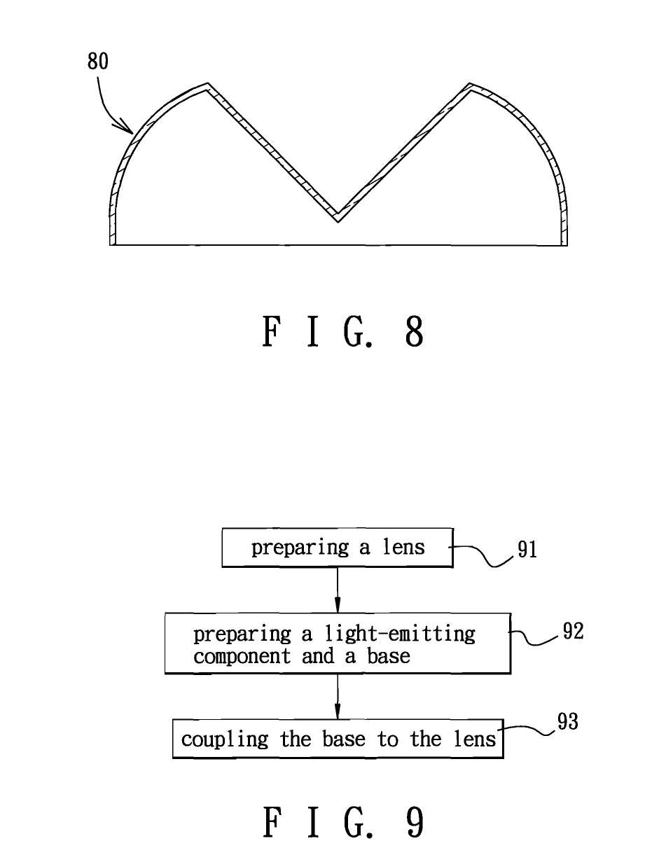

It should also be noted herein that the light-emitting device can be manufactured without the use of the mold 7. As shown in FIG. 7, this method begins in step 81, where a lens cap 80 (as shown in FIG. 8) is provided. The lens cap 80 has the shape of the lens body 40, i.e., the lens cap 80 has a top surface shaped to define a funnel-shaped space, and a projection of an outer periphery of an upper part of the lens cap 80 is completely surrounded by a projection of an outer periphery of a lower part of the lens cap 80. The only difference between the lens body 40 and the lens cap 80 is that the lens cap 80 is hollow.

Next, in step 82, the light-emitting component 3 and the base 2 are prepared, where the light-emitting component 3 is coupled to the base 2 through wire bonding.

Subsequently, the base 2 and the lens cap 80 are coupled together in step 83 such that the light-emitting component 3 is disposed under the lens cap 80.

Light-transmissive plastic material is then injected into the lens cap 80 in step 84, followed by curing the light-transmissive plastic material through baking in step 85. This method ends in step 86, where the reflective coating layer 421 is formed on the top surface of the lens cap 80. It should be noted herein that the reflective coating layer 421 can be provided on the top surface of the lens cap 80 at any time during the manufacturing procedure of the light-emitting device.

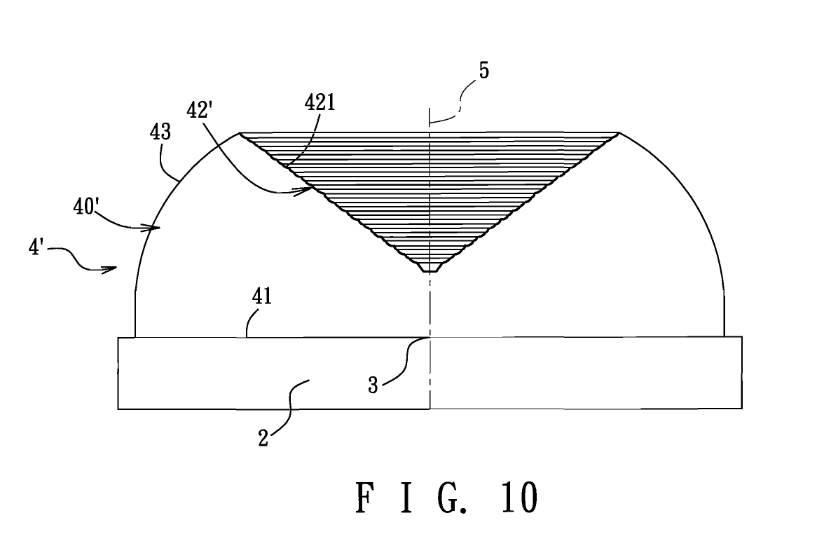

Furthermore, the present invention also provides a method for making the lens 4 independently before the light-emitting component 3 and the base 2 are assembled thereto to construct the light-emitting device. As shown in FIG. 9, the lens 4 is first prepared in step 91 with the reflective coating layer 421 formed thereon. Then, the light-emitting component 3 and the base 2 are prepared in step 92 by wire bonding the light-emitting component 3 to the base 2. Lastly, in step 93, the base 2 and the lens 4 are coupled together by applying an adhesive therebetween. This method is different from the previous method in that a pre-formed lens 4 is used instead of a hollow lens cap 80.

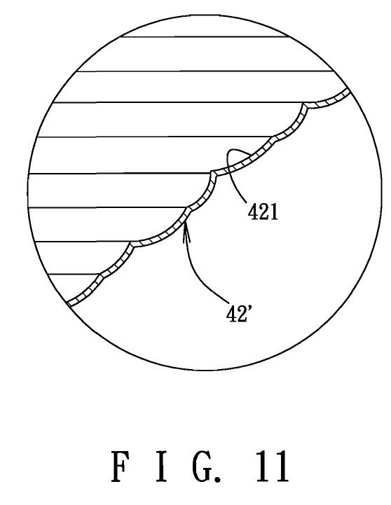

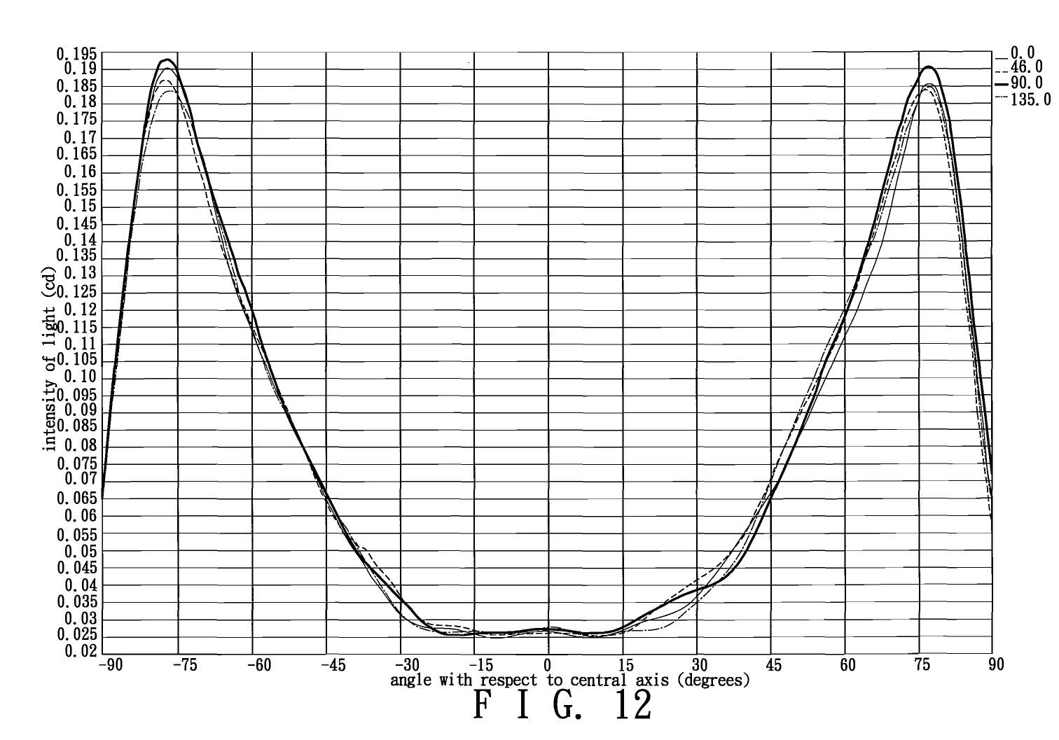

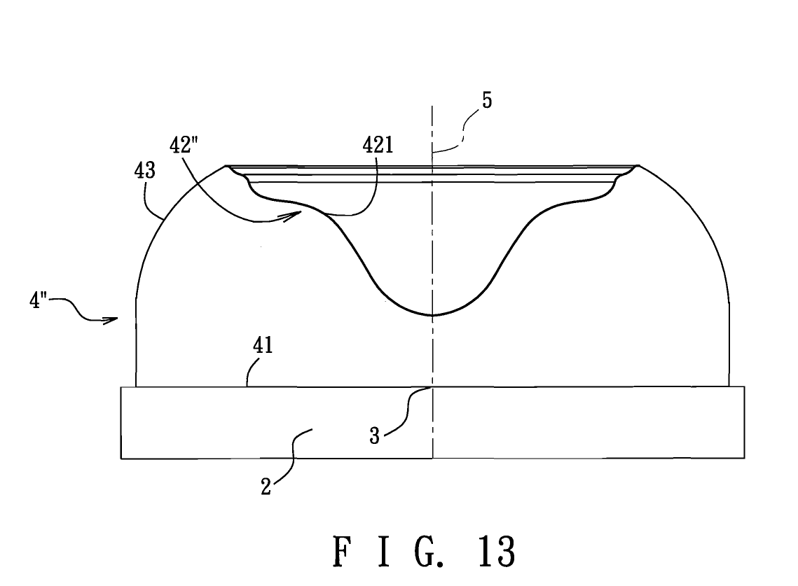

As shown in FIG. 10 and FIG. 11, the second preferred embodiment of a light-emitting device according to the present invention differs from the first preferred embodiment in that the reflective surface 42′ of the lens body 40′ of the lens 4′ has a plurality of steps such that the reflective surface 42′ is configured with a ladder-shaped cross section parallel to the central lens axis 5. Like the previous embodiment, the lens body 40′ has cross-sections transverse to the central lens axis 5, sizes of which increase gradually from the junction of the reflective surface 42′ and the refractive surface 43 toward the bottom surface 41 such that mold release of the lens body 40′ can be easily performed. As shown in FIG. 12, the intensity of radiated light forming relatively small angles (0° to 15°) with the central lens axis 5 is approximately zero, and the intensity of radiated light forming angles of approximately 80° with the central lens axis 5 is the highest. It is noted herein that the peak of the light intensity is shifted farther away from the central lens axis 5 (angle of 0°) as compared to the results shown in FIG. 4 for the first preferred embodiment. This implies that the configuration of the reflective surface 42′ enhances the ability in directing the light provided by the light-emitting component 3 in sideward directions.

Since optical paths of the light provided by the light-emitting component 3 in the lens 4′ and manufacturing methods of the light-emitting device are the same as those described hereinabove in connection with the previous embodiment, further details of the same are omitted herein for the sake of brevity. It should be noted, however, that surfaces of the mold (not shown) defining the mold cavities for this embodiment should be configured with a ladder-shaped cross section corresponding to that of the reflective surface 42′.

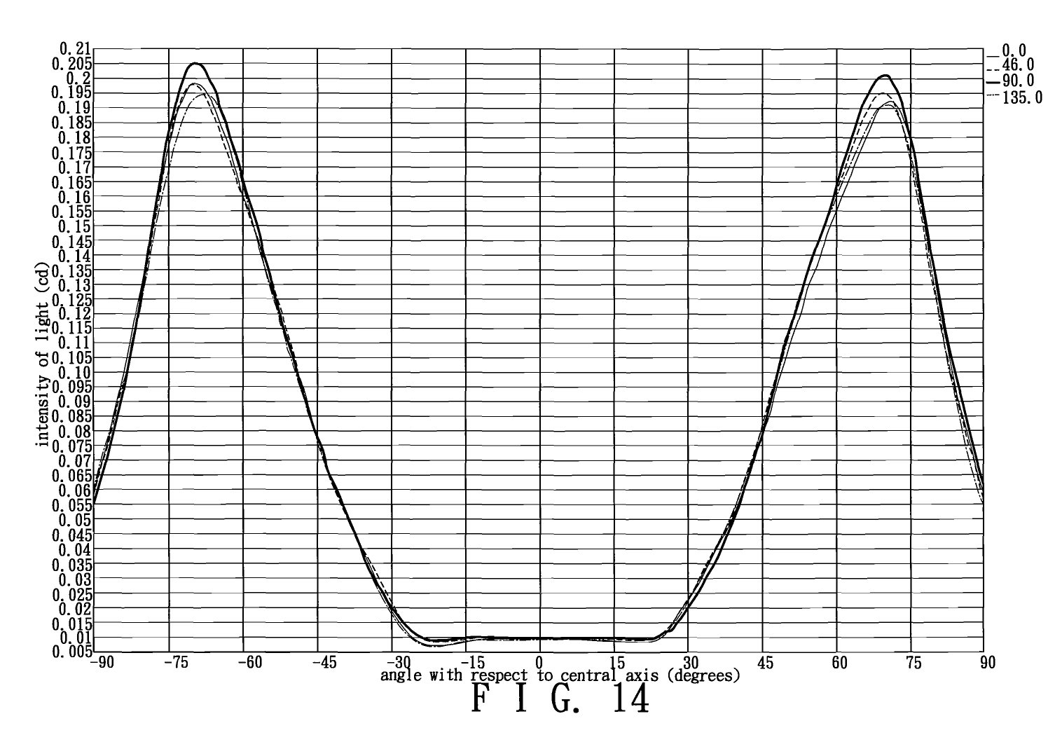

As shown in FIG. 13, the third preferred embodiment of a light-emitting device according to the present invention differs from the first preferred embodiment in that the reflective surface 42″ is a wavy surface, which includes consecutive wave segments having amplitudes that are measured with respect to the central lens axis 5 and that increase in a direction away from the bottom surface 41. The rate of change in the amplitude increases near the junction of the reflective surface 42″ and the refractive surface 43 such that the reflective surface 42″ is rounded at its center near the central lens axis 5, and is more leveled near the junction of the reflective surface 42″ and the refractive surface 43. Compared to the previous two embodiments, the third preferred embodiment is even more efficient in directing the light provided by the light-emitting component 3 in sideward directions out of the lens 4. As shown in FIG. 14, the intensity of radiated light forming relatively small angles (0° to 25°) with the central lens axis 5 is approximately zero, and the values are closer to zero than those of the previous embodiments. The intensity of radiated light forming angles of approximately 70° with the central lens axis 5 is the highest, and the values are higher than those of the previous embodiments at angles of approximately 80°.

In sum, by including the reflective coating layer 421 in the lens 4, 4′, 4″ according to the present invention, not only is a large portion of the light provided by the light-emitting component 3 directed in sideward directions out of the lens 4, but the percentage of light traveling approximately parallel to the central lens axis 5 is reduced significantly. Moreover, since the refractive surface 43 is designed as a curved surface instead of the sawtooth surface as taught in the prior art, and since the projection of the outer periphery of the upper body part of the lens body 40 on the bottom surface 41 is completely surrounded by the projection of the outer periphery of the lower body part on the bottom surface 41, manufacturing of the lens 4 is easier than in the prior art.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A lens for directing light provided by a light-emitting component sideways, said lens comprising a lens body having a bottom surface, a reflective surface, and a refractive surface, wherein:
said bottom surface is to be disposed proximate to the light-emitting component;
said reflective surface is disposed opposite to said bottom surface along a lens axis, and reflects a first portion of the light provided by the light-emitting component that is incident thereon toward said refractive surface;
said refractive surface extends from an edge of said reflective surface to said bottom surface, and refracts a second portion of the light provided by the light-emitting component that is incident thereon as well as the first portion of the light reflected by said reflective surface theretoward in sideward directions relative to the light-emitting component; and
said lens body has cross-sections transverse to the lens axis, sizes of which increase gradually from a junction of said reflective surface and said refractive surface toward said bottom surface.

2. The lens as claimed in claim 1, wherein said lens body has upper and lower body parts, a projection of an outer periphery of said upper body part on said bottom surface being completely surrounded by a projection of an outer periphery of said lower body part on said bottom surface.

3. The lens as claimed in claim 1, wherein said refractive surface is a curved surface.

4. The lens as claimed in claim 1, wherein said reflective surface is provided with a reflective coating layer, said reflective coating layer being one of a completely optically non-transmissive layer and a partially optically transmissive layer.

5. The lens as claimed in claim 1, wherein said reflective surface is a wavy surface.

6. The lens as claimed in claim 5, wherein said lens body is symmetrical about the lens axis, said wavy surface including consecutive wave segments having amplitudes that are measured with respect to the lens axis and that increase in a direction away from said bottom surface.

7. A lens for directing light provided by a light-emitting component sideways, said lens comprising a lens body having a bottom surface, a wavy surface, and a refractive surface, wherein:
said bottom surface is to be disposed proximate to the light-emitting component;
said wavy surface is disposed opposite to said bottom surface along a lens axis, and is capable of reflecting a first portion of the light provided by the light-emitting component that is incident thereon toward said refractive surface; and
said refractive surface extends from an edge of said wavy surface to said bottom surface, and refracts a second portion of the light provided by the light-emitting component that is incident thereon as well as the first portion of the light reflected by said wavy surface theretoward in sideward directions relative to the light-emitting component.

8. The lens as claimed in claim 7, wherein said refractive surface is a curved surface.

9. The lens as claimed in claim 7, wherein said wavy surface has a plurality of steps such that said wavy surface is configured with a ladder-shaped cross section parallel to the lens axis.

10. The lens as claimed in claim 7, wherein said lens body is symmetrical about the lens axis, said wavy surface including consecutive wave segments having amplitudes that increase in a direction away from said bottom surface.

11. A light-emitting device, comprising a base, a light-emitting component, and a lens, wherein:
said light-emitting component is mounted on said base; and
said lens directs light emitted by said light-emitting component sideways, said lens including a lens body that has a bottom surface, a reflective surface, and a refractive surface, said bottom surface being disposed proximate to said light-emitting component, said reflective surface being disposed opposite to said bottom surface along a lens axis, and reflecting a first portion of the light provided by said light-emitting component that is incident thereon toward said refractive surface, said refractive surface extending from an edge of said reflective surface to said bottom surface, and refracting a second portion of the light provided by said light-emitting component that is incident thereon as well as the first portion of the light reflected by said reflective surface theretoward in sideward directions relative to said light-emitting component, said lens body having cross-sections transverse to the lens axis, sizes of which increase gradually from a junction of said reflective surface and said refractive surface toward said bottom surface.

12. The light-emitting device as claimed in claim 11, wherein said lens body has upper and lower parts, a projection of an outer periphery of said upper body part on said bottom surface being completely surrounded by a projection of an outer periphery of said lower body part on said bottom surface.

13. The light-emitting device as claimed in claim 11, wherein said refractive surface of said lens is a curved surface.

14. The light-emitting device as claimed in claim 11, wherein said reflective surface is provided with a reflective coating layer.

15. The light-emitting device as claimed in claim 11, wherein said reflective surface has a plurality of steps such that said reflective surface is configured with a ladder-shaped cross section parallel to the lens axis.

16. The light-emitting device as claimed in claim 11, wherein said reflective surface is a wavy surface.

17. The light-emitting device as claimed in claim 16, wherein said lens body is symmetrical about the lens axis, said wavy surface including consecutive wave segments having amplitudes that are measured with respect to the lens axis and that increase in a direction away from said bottom surface.

18. A light-emitting device comprising a base, a light-emitting component, and a lens, wherein:
said light-emitting component is mounted on said base; and
said lens directs light emitted by said light-emitting component sideways, said lens including a lens body that has a bottom surface, a wavy surface and a refractive surface,
said bottom surface being disposed proximate to the light-emitting component,
said wavy surface being disposed opposite to said bottom surface along a lens axis, and being capable of reflecting a first portion of the light provided by said light-emitting component that is incident thereon toward said refractive surface,
said refractive surface extending from an edge of said wavy surface to said bottom surface, and refracting a second portion of the light provided by said light-emitting component that is incident thereon as well as the first portion of the light reflected by said wavy surface theretoward in sideward directions relative to the light-emitting component.

19. The light-emitting device as claimed in claim 18, wherein said refractive surface is a curved surface.

20. The light-emitting device as claimed in claim 18, wherein said wavy surface is provided with a reflective coating layer.

21. The light-emitting device as claimed in claim 18, wherein said wavy surface has a plurality of steps such that said wavy surface is configured with a ladder-shaped cross section parallel to the lens axis.

22. The light-emitting device as claimed in claim 18, wherein said lens body is symmetrical about said lens axis, said wavy surface including consecutive wave segments having amplitudes that increase in a direction away from said bottom surface.
